(19) United States
(12) Patent Application Publication
(10) Pub. No.: US 2003/0197436 A1
(43) Pub. Date: Oct. 23, 2003

(54) Disk rotating motor and disk apparatus

(76) Inventor: Atsushi Takahashi, Kunitachi-shi (JP)

Correspondence Address: PILLSBURY WINTHROP, LLP, P.O. BOX 10500, MCLEAN, VA, 22102, US

(21) Appl. No.: 10/232,669

(22) Filed: Sep. 3, 2002

(30) Foreign Application Priority Data
Apr. 21, 2002 (JP) 2002-122727

(51) Int. Cl. H02K 7/00; H02K 11/00

(52) U.S. Cl. 310/67 R

(57) ABSTRACT

An HDD has a spindle motor that supports a magnetic disk such that the disk can rotate. The spindle motor is formed by attaching a rotatable hub to the bottom plate of a housing, providing a magnet concentric with the hub, and providing a stator coil concentric with the magnet, with a predetermined gap therebetween. Further, a yoke is attached to the surface of the magnet opposing the bottom plate, thereby blocking the leakage of magnetic flux directed from the magnet to the bottom plate. As a result, the rotational loss of the hub due to the leakage of magnetic flux can be suppressed, and hence the rotational efficiency of the motor can be enhanced.

### CROSS-REFERENCE TO RELATED APPLICATIONS

This application is based upon and claims the benefit of priority from the prior Japanese Patent Application No. 2002-122727, filed Apr. 24, 2002, the entire contents of which are incorporated herein by reference.

### BACKGROUND OF THE INVENTION

1. Field of the Invention

The present invention relates to a disk apparatus for recording/reproducing data to/from a disk medium, and a disk rotating motor for rotating the disk medium.

2. Description of the Related Art

As a disk apparatus, a hard disk drive apparatus (hereinafter referred to simply as an “HDD”) for recording/reproducing data to/from a magnetic disk is known.

HDDs comprise a spindle motor for supporting and rotating a magnetic disk, a head for recording/reproducing data to/from the magnetic disk, a suspension arm mounted with the head at its free end, and a voice coil motor for radially swinging the suspension arm to radially move the head over the magnetic disk to a desired track thereon.

The spindle motor disclosed in Jpn. Pat. Appln. KOKAI Publication No. 4-112655, for example, is known as a spindle motor for HDDs.

This spindle motor comprises a substantially cylindrical hub that supports the center of rotation of a magnetic disk, a cylindrical magnet provided on the outer peripheral surface of the hub, and a stator coil provided outside the magnet, concentric therewith, etc. The hub has a substantially cylindrical shield plate interposed between the magnet and magnetic disk.

This shield plate functions to form a magnetic circuit that connects the magnet to the stator coil, and also to suppress the leakage of magnetic flux directed to the magnetic disk.

In general, an HDD spindle motor is arranged such that its hub is rotatably attached to the housing formed of die cast conductive aluminum. In the thus-constructed conventional spindle motor, when the magnet attached to the hub rotates, eddy currents occur through the housing close to the magnet, thereby reducing the rotational efficiency of the motor.

In addition, to meet the recent demand for downsizing, a housing formed of a pressed iron plate has often come to be employed instead of the aluminum housing of insufficient rigidity. However, if such a housing made of a magnetic substance is employed, a new problem may occur in which a magnetic force is exerted between the magnet, attached to the hub, and the housing, thereby also reducing the rotational efficiency of the motor.

### BRIEF SUMMARY OF THE INVENTION

The present invention has been developed in light of the above and aims to provide a disk rotating motor with a low rotational loss due to the leakage of magnetic flux, and accordingly having a high rotational efficiency, and a disk apparatus equipped with the motor.

To satisfy the aim, according to an aspect of the invention, there is provided a disk rotating motor comprising: a hub supporting a center of rotation of a disk medium; a base member supporting the hub such that the hub can rotate; a substantially cylindrical magnet fixed to the hub, concentric with the hub; a stator coil fixed to the base member, concentric with the magnet, and opposing the magnet with a predetermined gap therebetween; and a shield member attached to a side of the magnet, the side opposing the base member, the shield member blocking leakage of magnetic flux directed from the magnet to the base member.

As described above, the disk rotating motor of the invention is formed by attaching the hub to the base member so that the hub can rotate, providing the magnet concentric with the hub, and providing the stator coil concentric with the magnet, with a predetermined gap therebetween. Further, the shield member is attached to the side of the magnet opposing the base member, thereby blocking the leakage of magnetic flux directed from the magnet to the base member. As a result, the rotational loss of the hub due to the leakage of magnetic flux can be suppressed, and hence the rotational efficiency of the motor can be enhanced.

According to another aspect of the invention, there is provided a disk apparatus comprising: a disk medium; a spindle motor which supports and rotates the disk medium; an arm provided with a head at a free end thereof, the head being used to record and/or reproduce data to and/or from the disk medium while the disk medium is rotating; a voice coil motor which swings the arm to thereby substantially radially move the head to a desired track of the disk medium; and a housing which houses the disk medium, the spindle motor, the arm and the voice coil motor, wherein the spindle motor comprises: a hub supporting a center of rotation of the disk medium, the hub being rotatably attached to the housing; a substantially cylindrical magnet fixed to the hub, concentric with the hub; a stator coil fixed to the housing, concentric with the magnet, and opposing the magnet with a predetermined gap therebetween; and a shield member attached to a side of the magnet, the side opposing the housing, the shield member blocking leakage of magnetic flux directed from the magnet to the housing.

According to yet another aspect of the invention, there is provided a disk rotating motor comprising: a hub supporting a center of rotation of a disk medium; a base member supporting the hub such that the hub can rotate; a substantially cylindrical magnet fixed to the hub, concentric with the hub; a stator coil fixed to the base member, concentric with the magnet, and opposing the magnet with a predetermined gap therebetween; and a shield member which blocks leakage of magnetic flux other than magnetic flux directed from the magnet to the stator coil, thereby enhancing a rotational efficiency of the hub.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exploded perspective view illustrating an HDD according to the invention;

FIG. 2 is a sectional view illustrating a spindle motor according to a first embodiment employed in the HDD of FIG. 1; and

FIG. 3 is a sectional view illustrating a spindle motor according to a second embodiment.

### DETAILED DESCRIPTION

Embodiments of the invention will now be described in detail with reference to the accompanying drawings.

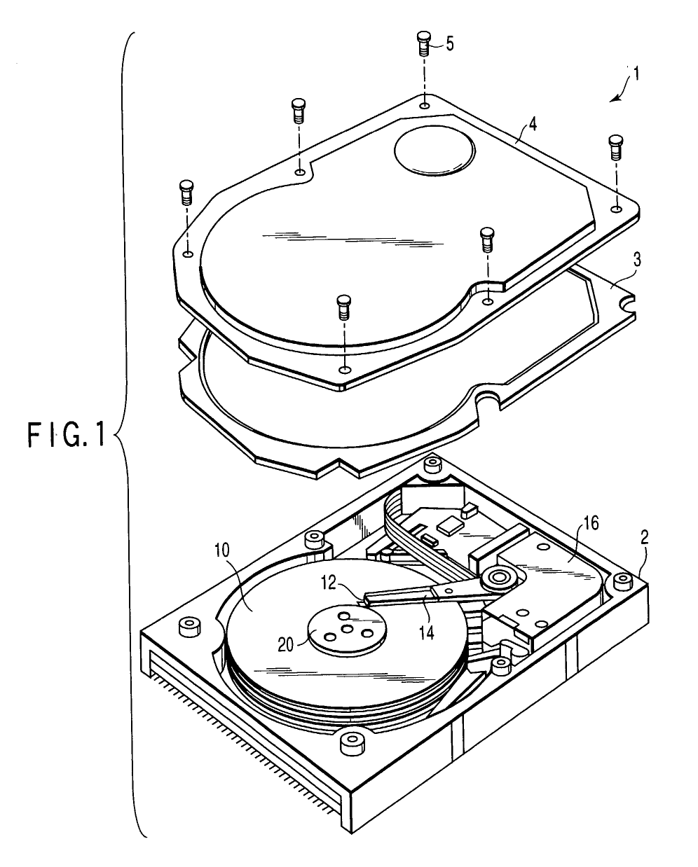

FIG. 1 is an exploded perspective view illustrating an HDD (disk apparatus) according to the invention.

As shown, an HDD 1 comprises a substantially rectangular housing 2 (base member) with an upper opening, and a top cover 4. The housing 2 is an aluminum die casting (conductive member) or an iron plate (magnetic member). The top cover 4 is attached to the housing 2 by plural screws 5 with a gasket 3 interposed therebetween, thereby closing the upper opening of the housing.

The housing 2 houses a magnetic disk 10, a spindle motor 20 (disk rotating motor) that supports the magnetic disk 10 so that the disk can rotate, a head 12 for recording and/or reproducing data to and/or from the magnetic disk 10, a suspension arm 14 mounted with the head 12 at its free end, and a voice coil motor 16 for radially swinging the suspension arm 14 to substantially radially move the head 12 over the magnetic disk 10, etc.

When data is recorded/reproduced on/from the magnetic disk 10, the spindle motor 20 rotates the magnetic disk 10, and the voice coil motor 16 swings the suspension arm 14, thereby positioning the head 12 on a desired track (not shown) of the magnetic disk 10.

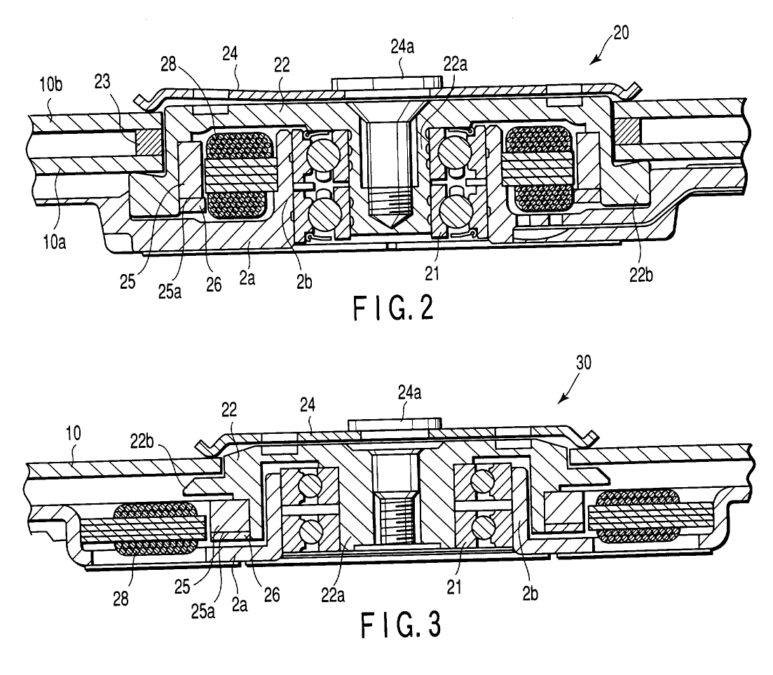

FIG. 2 is a sectional view illustrating a spindle motor 20 of an outer rotor type according to a first embodiment of the invention. The spindle motor 20 is mounted in the HDD 1 that has, for example, two magnetic disks with a diameter of 2.5 inches.

The spindle motor 20 has a hub 22 rotatably attached to the bottom plate 2a of the housing 2 (an aluminum die casting in this embodiment). The hub 22 is arranged such that its rotational axis 22a is inserted inside a ball bearing 21 located inside a cylindrical portion 2b that is formed integrally with and projecting from the bottom plate 2a.

A substantially annular flange 22b is formed integrally with the outer peripheral portion of the hub 22 close to the bottom plate 2a. The flange 22b holds two magnetic disks 10a and 10b.

Specifically, the hub 22 is inserted in a circular hole formed in a central portion (i.e., around the axis of rotation) of the magnetic disk 10a, such that the disk 10a is engaged with the flange 22b. Subsequently, the other magnetic disk 10b is mounted on the hub with a cylindrical spacer interposed therebetween. A substantially circular clamp plate spring 24 is placed on the upper magnetic disk lob, and is positioned there using a tool (not shown). After that, a screw 24a is screwed into the center of the resultant structure. The spring force of the clamp plate spring 24 fixes the magnetic disks 10a and 10b to the hub 22.

A cylindrical magnet 25 is attached to the inner periphery of the hub 22, concentric therewith. An annular yoke 26 (shield member) is attached to the lower surface 25a (counter surface) of the magnet 25 opposing the bottom plate 2a. The yoke 26 is formed of a magnetic member, such as an iron plate, a magnetic stainless steel plate or a permalloy plate, etc., which has a size that can cover at least the entire lower surface 25a of the magnet 25. In this structure, the yoke 26 is magnetically held by the lower surface 25a of the magnet 25. The yoke 26 functions to block the leakage of magnetic flux directed from the magnet 25 to the bottom plate 2a. To enhance the reliability of fixing, the yoke 26 may be adhered to the lower surface 25a of the magnet 25, using an adhesive.

A stator coil 28 is provided on the outer periphery of the cylindrical portion 2b of the housing 2. In other words, the stator coil 28 is provided inside the magnet 25, concentric therewith, with a predetermined gap therebetween. The stator coil 28 is formed of four stacked magnetic plates wound with a coil, and is fixed to the housing 2.

In this structure, when a controlled current is passed through the stator coil 28, a magnetic circuit is formed between the coil 28 and magnet 25, whereby the hub 22 is rotated together with the magnet 25. At this time, the yoke 26 of the spindle motor 20 of the embodiment blocks the leakage of magnetic flux directed from the magnet 25 to the bottom plate 2a. As a result, the occurrence of eddy currents through the bottom plate 2a can be prevented, thereby suppressing the reduction of the rotational efficiency of the spindle motor due to the eddy currents.

FIG. 3 is a sectional view illustrating a spindle motor 30 of an inner rotor type according to a second embodiment. In the spindle motor 30, since the magnet 25 is located inside the stator coil 28, the entire motor size can be reduced as compared to the spindle motor 20 of the first embodiment. Accordingly, the spindle motor 30 is mounted in, for example, a relatively small HDD 1 designed for a disk diameter of 1.8 inches. The spindle motor 30 comprises substantially the same elements as the spindle motor 20 of the first embodiment. Therefore, such elements are denoted by corresponding reference numerals, and no detailed description is given thereof.

The spindle motor 30 has a hub 22 rotatably attached to the bottom plate 2a of a housing 2 (made of iron in this embodiment). The hub 22 is arranged such that its rotational axis 22a is inserted inside a ball bearing 21 located inside a cylindrical portion 2b that is formed integrally with and projecting from the bottom plate 2a.

A substantially annular flange 22b is formed integrally with the outer peripheral portion of the hub 22. The flange 22b holds a magnetic disk 10. Specifically, the hub 22 is inserted in a circular hole formed in a central portion of the magnetic disk 10, such that the disk 10 is engaged with the flange 22b. A substantially circular clamp plate spring 24 is placed on the magnetic disk 10, and is positioned there using a tool (not shown). After that, a screw 24a is screwed into the center of the resultant structure. The spring force of the clamp plate spring 24 fixes the magnetic disk 10 to the hub 22.

A cylindrical magnet 25 is attached to the outer periphery of the hub 22, concentric therewith, below the flange 22b. An annular yoke 26 (shield member) is attached to the lower surface 25a (counter surface) of the magnet 25 opposing the bottom plate 2a. The yoke 26 is formed of a magnetic member having a size that can cover at least the entire lower surface 25a of the magnet 25. In this structure, the yoke 26 is magnetically held by the lower surface 25a of the magnet 25. The yoke 26 functions to block the leakage of magnetic flux directed from the magnet 25 to the bottom plate 2a.

A stator coil 28 is provided outside the magnet 25, concentric therewith, with a predetermined gap therebetween. The stator coil 28 is fixed to the housing 2. In this structure, when a controlled current is passed through the stator coil 28, a magnetic circuit is formed between the coil 28 and magnet 25, whereby the hub 22 is rotated together with the magnet 25.

As described above, in the spindle motor 30 of this embodiment, the leakage of magnetic flux directed from the magnet 25 to the bottom plate 2a is blocked by the yoke 26, which prevents a magnetic force from acting upon the bottom plate 2a made of iron. As a result, the occurrence of a resistance against rotation due to the magnetic force can be avoided, and hence the rotational efficiency of the spindle motor 30 is enhanced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

For example, although in the above-described embodiments, the ball bearing 21 is used to support the hub 22 so that the hub can rotate, a dynamic pressure fluid bearing may be used instead of the ball bearing.

What is claimed is:

1. A disk rotating motor comprising:
a hub supporting a center of rotation of a disk medium;
a base member supporting the hub such that the hub can rotate;
a substantially cylindrical magnet fixed to the hub, concentric with the hub;
a stator coil fixed to the base member, concentric with the magnet, and opposing the magnet with a predetermined gap therebetween; and
a shield member attached to a side of the magnet, the side opposing the base member, the shield member blocking leakage of magnetic flux directed from the magnet to the base member.

2. A disk rotating motor according to claim 1, wherein the base member is a magnetic member.

3. A disk rotating motor according to claim 1, wherein the base member is a conductive member.

4. A disk rotating motor according to claim 1, wherein the shield member has a size which covers a counter surface of the magnet opposing the base member.

5. A disk apparatus comprising:
a disk medium;
a spindle motor which supports and rotates the disk medium;
an arm provided with a head at a free end thereof, the head being used to record and/or reproduce data to and/or from the disk medium while the disk medium is rotating;
a voice coil motor which swings the arm to thereby substantially radially move the head to a desired track of the disk medium; and
a housing which houses the disk medium, the spindle motor, the arm and the voice coil motor,
wherein the spindle motor comprises:
a hub supporting a center of rotation of the disk medium, the hub being rotatably attached to the housing;
a substantially cylindrical magnet fixed to the hub, concentric with the hub;
a stator coil fixed to the housing, concentric with the magnet, and opposing the magnet with a predetermined gap therebetween; and
a shield member attached to a side of the magnet, the side opposing the housing, the shield member blocking leakage of magnetic flux directed from the magnet to the housing.

6. A disk apparatus according to claim 5, wherein the housing is a magnetic member.

7. A disk apparatus according to claim 5, wherein the housing is a conductive member.

8. A disk apparatus according to claim 5, wherein the shield member has a size which covers a counter surface of the magnet opposing the housing.

9. A disk rotating motor comprising:
a hub supporting a center of rotation of a disk medium;
a base member supporting the hub such that the hub can rotate;
a substantially cylindrical magnet fixed to the hub, concentric with the hub;
a stator coil fixed to the base member, concentric with the magnet, and opposing the magnet with a predetermined gap therebetween; and
a shield member which blocks leakage of magnetic flux other than magnetic flux directed from the magnet to the stator coil, thereby enhancing a rotational efficiency of the hub.

10. A disk rotating motor according to claim 9, wherein the shield member is provided at a location at which the shield member can block leakage of magnetic flux directed from the magnet to the base member.

11. A disk rotating motor according to claim 10, wherein the base member is a magnetic member.

12. A disk rotating motor according to claim 10, wherein the base member is a conductive member.

13. A disk rotating motor according to claim 10, wherein the shield member has a size which covers a counter surface of the magnet opposing the base member.
